(19) United States
(12) Patent Application Publication
(10) Pub. No.: US 2003/0176198 A1
(43) Pub. Date: Sep. 18, 2003

(54) Communication system

(76) Inventor: John P. Chisholm, Reno, NV (US)

Correspondence Address: IAN F. BURNS & ASSOCIATES, 1575 DELUCCHI LANE, SUITE 222, RENO, NV, 89502, US

(21) Appl. No.: 10/388,550

(22) Filed: Mar. 14, 2003

Related U.S. Application Data
(60) Provisional application No. 60/365,207, filed on Mar. 14, 2002.

(51) Int. Cl. H04Q 7/20

(52) U.S. Cl. 455/463; 455/464

(57) ABSTRACT

A method for communication involving a plurality of communication devices. A common time base is established among the communication devices and the common time base is then arranged into a repeating cycle of time intervals. The time intervals are arranged into a number of time slots. In one embodiment, at least one time slot is designated as unique and the communication devices are tuned from a first frequency to a second frequency on the occurrence of the unique time slot and the communication devices may receive during the unique time slot. In another embodiment, a time slot is assigned to each communication device, the time slot is unique to each communication device. The communication device is tuned from a first frequency to a second frequency on the occurrence of the communication device's unique time slot and the communication device may transmit during the unique time slot.

### CROSS REFERENCE TO RELATED APPLICATIONS

This application claims the benefit of provisional application serial No. 60/365,207, filed Mar. 14, 2002.

### BACKGROUND OF THE INVENTION

1. Field of the Invention

The present invention relates to methods for communicating voice and other data. In particular, the present invention provides methods for multi-user radio communication.

2. Description of the Related Art

In fire suppression activities, the safety of personnel is the dominant consideration. The safety of personnel can be increased if a fire commander has knowledge of the location of personnel with respect to the location of the fire. Personnel location data is best obtained when the personnel communicate their location to the fire commander.

The fire commander ideally is provided with knowledge of the location of personnel, so that the personnels' location with respect to the fire can be calculated and can be compared with the movement of the fire. The fire commander can then act to insure that personnel are safe, for example, from being overrun by a wildfire, or caught in a collapsing building. When the fire commander feels it is necessary to take action to protect personnel, the fire commander typically issues instructions to personnel. For example, instructions may be to evacuate a particular area or building.

The communication of data between the fire commander and personnel, such as location data and instructions, requires a reliable two-way communications system. In fire suppression activities, such as wildfires or fires in large structures, communication between personnel and a central command post are generally implemented via voice radios. Current radio practice has significant limitations under such circumstances. These limitations can have dire consequences, as they did in the Sadler fire in Elko, Nev. in 1999.

The Sadler fire entrapment occurred when a crew involved in setting a backfire was overrun by the main fire. Basic problems were that the backfire was set by personnel without knowledge of the location of the main fire and who had poor radio communication. The location of the main fire could not be visually observed by the personnel setting the backfire because of an intervening hill that obscured the main fire location from the backfire crew. The lack of effective radio communication prevented the backfire crew from learning of the main fire's location from other personnel with knowledge of the location of the main fire. The following are excerpts from the Sadler Fire Entrapment Investigation report, dated Aug. 9, 1999 from the Bureau of Land Management, of the Dept. of the Interior:

No one on the dozer line could see the main fire until just before the firing squad was overrun. Because of intense radio traffic, most of the personnel on division Q were not in contact with anyone who could see the main fire. The tactical channel was grossly overloaded and the command channel was clogged with logistics' traffic. In the minutes before being overrun, Horton did not hear repeated radio calls directing the squad to move to a safety zone. Horton had no communication with lookouts, and was unaware of the location of the main fire until just before the entrapment.

A similar lack of reliable communication also exists between participants in large structural fires. A more recent example of such limitations was well documented in a Jan. 30, 2002 New York Times article on the Sep. 11, 2001 World Trade Center catastrophe where over 300 firefighters perished. That article, and others on the September 11 disaster, makes it clear that a fire commander charged with the job of directing the suppression of a large structural fire has limited knowledge of the location of the fireman involved in the suppression activity and limited, or non existent, reliable radio communication with the fireman.

Of additional significance in the September 11 fire was that, when the threat of the building collapsing became apparent at the city's Emergency Headquarters, personnel at the headquarters could not reach the ranking fire chief by radio to inform him of the pending collapse. It was necessary to send a messenger on foot. The foot messenger delivered the message of the impending collapse to the ranking fire chief less than a minute before the building collapsed. If the fire chief had effective radio communication, countless lives might have been saved.

More recently, in connection with the problem of Homeland Security, there have been numerous press comments to the effect that the police radio network cannot be used to communicate with the fire suppression radio network and vice versa. If and when another terrorist attack occurs, this lack of intercommunication between various emergency and law enforcement personnel will likely lead to additional chaos in an already confused situation.

The above discussion makes it clear that communication involving multiple fire personnel, as well as other first responders, such as the police, must be dramatically improved-whether the personnel are communicating with each other or with a command center. In this connection, it is appropriate to first review a current effort to improve communication between other types of mobile participants.

Air Traffic Control (ATC)

One example of technology being used to improved communication between multiple participants is the ATC system. In current ATC practice, the locations of multiple participants, aircraft, are established by a surveillance radar system. The collected location data is displayed for use by an air-traffic controller. The controller, viewing the display, issues instructions via voice radio to insure that there will be an efficient flow of traffic into and out of airports. At the same time, the controller ensures that the aircraft are safely separated so that they will not collide with each other.

With the increasing number of aircraft occupying the airspace around busy airports, attention is now being focused on a somewhat different approach to the air-traffic control. A problem with the current system is it's extensive network of surveillance radars and associated multiple participant communication system. Under this newly evolving procedure, each aircraft carries a Global Positioning System (GPS) unit that establishes, in the aircraft, the precise location of the aircraft. In addition, the aircraft carries an added radio that can broadcast the GPS derived location of the aircraft, as well as receive location data broadcast by other aircraft, and receive data transmitted from the ground. When the broadcast location data of other aircraft are received by a first aircraft, it can be used to generate a pilot's display of the location of other aircraft for pilot use in avoiding such other aircraft. The aircraft broadcast location data, when received on the ground, can be displayed for use, as in current practice, by an air-traffic controller. The acronym Airborne Dependent Surveillance Broadcast (ADS-B) is applied to this evolving concept.

There are currently three competing candidates for the airborne ADS-B transmitter and receiving system. The three candidates are the Universal Access Transceiver (UAT) employed in the Alaskan based Capstone operational evaluation of the ADS-B concept, a version of the currently employed secondary surveillance radar (SSR) mode A/C transponder (referred to as “Mode S”), and the VDL-4 unit. The ADS-B and Mode S communication links operate in the vicinity of a thousand MHz. The VDL-4 unit operates in the VHF range.

The broadcast update rate that is considered desirable for collision avoidance purposes is once a second. The UAT link, for example, in order to accommodate a once per second broadcast of the nominally 250 bit GPS location data package for hundreds of aircraft, utilizes a wide band single frequency link with a nominal bit rate of a million bits per second. Such a bit rate requires the use of a wide band channel in the vicinity of 1000 MHZ; wide band channels are available at this frequency. The VDL-4 unit operates at the VHF range, where wide band channels are not available. Therefore, the VDL-4 link requires the use of multiple channels for operation when the number of aircraft involved is large.

In addition to the aircraft broadcasting location data, ground-based versions of the link are also employed. The receiver portion is used to receive aircraft transmissions of location data for display and use by air traffic controllers. The transmitting portion of a ground radio is used to broadcast data to the aircraft and can be used in the aircraft for enhancing flight safety, etc. One example of such a ground-based broadcast is the transmission of the isoecho contours of the precipitation rate of a thunderstorm observed by a ground-based weather radar. That weather radar data, when displayed to the pilot of an aircraft without a weather radar, can be used by the pilot to fly a course to avoid a thunderstorm.

The UAT broadcast of ground-based transmissions, isoecho contours for example, are assigned a unique time slot in a recurring series of time slots that repeat at the noted once per second rate. The aircraft broadcasts occur in a random manner. In both current and future ATC practice, the existing voice radio network will still be employed for both air-to-air, ground-to-air and air-to-ground voice communication.

Fire Suppression

Another situation of national interest involving multiple participants is that of fire suppression. In the case of a very severe wildfire, hundreds of personnel are assembled to suppress the fire. It is desirable, if not mandatory, that an efficient communication system be established between both the personnel and between the personnel and one or more control centers. In addition, it is highly desirable that that the location of the personnel be collected and displayed at these control centers for purposes of improving operational efficiency and enhancing personnel safety.

The current communications system employed in fire suppression activity is voice radio. In the case of a severe fire, multiple frequency channels are allocated to this voice communication process. However, even with the availability of multiple channels, the voice communication system is often, if not typically, overloaded to the detriment of suppression activities. This was the case in the previously discussed Sadler fire.

One of the reasons for such overloading is that voice communication is utilized to transmit data such as, for example, the GPS derived location of multiple mobile personnel, the visually established location of the fire, the arrival of, or the lack of, supplies at a fire camp etc. Voice communication of data, in contrast to digital communication, is an extremely inefficient use of the spectrum available. It is thus desirable to devise a method for communicating the required data that makes efficient use of the spectrum allocated to a particular fire suppression activity. In addition, it is desirable that the broadcast and reception of such data utilize the radios employed for voice communication. It is desirable that the transmission and reception of such data not interfere with the voice communication practice employed in current suppression activities, but rather enhances such voice communication capabilities.

The requirement that data communication utilize the radios employed for voice communication is that whereas aircraft can readily install an additional radio to accommodate a new type of communication, a ground-based personnel involved in strenuous fire suppression activities is already burdened with the tools of the trade such as fire axes etc., and hence imposing the additional burden of an added radio on such personnel is not desirable.

To summarize, the ideal communications system for fire suppression activities is one that utilizes existing radios for participants to communicate via voice to other personnel, as in current practice, and additionally can transmit data in a digital manner to one or more locations for processing, display, analysis and use, as, for example, in ATC practice. In addition, such radios should be able to receive processed data from such central locations for use in enhancing both personnel's operational efficiency as well as enhancing personnel safety.

In many ways the desired improvements to a fire suppression communication system, as well as many other events of national significance, such as nuclear or biological events resulting from terrorist activities, parallel those being gradually introduced into emerging ATC practice. A basic difference however is to implement such improvements in a manner that utilizes the radios already utilized for voice communication so as to not additionally burden already overburdened personnel. An additional requirement is to provide this added capability without interfering with ongoing voice communication. As noted above the communication link employed in emerging ADS-B ATC practice utilizes an added radio.

Advantages of One or More Embodiments of the Present Invention

The various embodiments of the present invention may, but do not necessarily, achieve one or more of the following advantages:

the ability to allow a central location to communicate an emergency message to field personnel;

the ability to use a single radio to perform voice, data, and/or emergency message notification communication;

the ability for field personnel to digitally communicate data to a central location without significant interference with voice communication; and

provide increased safety for field personnel.

These and other advantages may be realized by reference to the remaining portions of the specification, claims, and abstract.

Opportunity for Improvements over Prior Art Communication

There are several factors, not critical to my invention process, that facilitate the implementation of the desired improvements in a cost effective matter via the use of existing radios. One factor is that the data update rate, in fire suppression activities for example, can be much lower than that required in ATC practice. This is because the speed with which the multiple personnel move about in a ground based situation is much slower than the speed of the aircraft involved in ATC practice. This slower speed, of the order of the ratio of 600 knots to say six knots, permits a reduction in the update rate from once every second to once every hundred seconds, for example. In turn, this reduction decreases the one MHz per second data rate required in ATC practice to say 10,000 bits per second. This data rate can be accommodated by currently available Part 25 digital radios (available from Motorola), which are being introduced into wildfire suppression activities by organizations such as the Bureau of Land Management.

Another factor is that the communication of data, such as location data, in a more efficient digital manner (rather than by voice) lessens the burden on voice communication channels and hence acts to make available one of the frequency channels assigned to fire suppression activities.

The above two features that provide an opportunity for improvement are not critical to the inventive process.

There are however two features that contribute to the invention. These are the ability of a communication device to change frequency in a very short time, as short as one milliseconds, as taught in my U.S. Pat. No. 3,821,253 thus permitting a designated frequency to be used for data communication without interfering with ongoing voice communication.

A second feature contributing to the invention is the use of a Time Division multiple access communication structure in which operation is divided into a repeating cycle of time intervals and the time slots can be used for the exchange of data without interference among mobile personnel.

A Time Division multiple access communication system requires a common time base among such the mobile complexity as taught in my prior art teachings, U.S. Pat. No. 3,153,232. Currently the availability of very compact and low-cost GPS units, which not only provide precise location data but also as a worldwide common time base removes the obstacle. This patent application is based on the inventive combination of my prior art teachings, which teachings are elaborated on in some detail in the discussion of my embodiments.

A third factor is the use of a synchronized time sharing method and a system for adding an emergency message communication capability, in a non interfering manner, to the normal voice radio communication of multiple participants.

To Summarize the application of my prior art of Frequency Agility and Time Division Multiple Access Communications structure to improving communication, normal voice and emergency communication are simultaneously implemented in a non interfering manner by first assigning a unique time slot in a repeating cycle of such time slots, in a common time base, to each participant for Emergency Message Notification (EMN) communication purposes. During this EMN time slot, when an emergency message may or may not be transmitted, an Emergency Message Notification signal will be broadcast indicating that an emergency message will or will not follow. The Emergency Message Notification signal broadcast in the assigned time slot will be transmitted on a frequency allocated for this emergency function.

During this time slot, participant radios intended to receive emergency messages will have their radios, in use for normal voice communication on a channel assigned for voice communication, tuned to receive on the emergency communication channel. This Emergency Message Notification signal, if it indicates that an emergency message will follow, will, when received, act to insure that the participant radio will stay tuned to receive the emergency message for the duration of the emergency message that follows. At the end of the emergency message, the radio will revert to the channel and mode previously in use for normal voice communication. If the emergency message notification signal broadcast indicates that an emergency message will not follow, the radio will then be immediately reset to its previous mode for normal voice communication.

The tuning of the radio to the emergency channel, and the length of the time slot used to broadcast and receive data indicating that an emergency message may or may not follow, is sufficiently short, of the order of a very small fraction of a second, and the time interval between the reoccurrence of the emergency message notification time slots is sufficiently long, that the interruption in an ongoing normal voice communication process does not significantly impact that process. There can, of course, be a noticeable interruption in ongoing voice communication during the broadcast and reception, if it occurs, of the emergency message. Emergency messages will obviously occur infrequently and typically be of short duration, such as “evacuate the building,” hence their impact on normal voice radio communication will be minor.

The channel utilized for the broadcasting of an emergency message could be one normally used for voice communication. The channel could also be one dedicated to such emergency communication use, as well as other data communication uses. One such other use that is compatible with my synchronized time sharing method of communication is the broadcasting of participant data, such as participant location.

This broadcasting of participant data is accomplished by assigning each participant a time slot in a common time base. This time slot is unique to each participant and is in addition to the EMN time slot that is the same for all participants. The unique time slot provides the participant a period to broadcast, in a digital manner, data pertinent to fire suppression activities. Participant location is one such set of data. Participant location, as well as the common time base required to implement my synchronized time sharing method of communication, are readily available using compact low-cost GPS units.

The participant data broadcasting function is implemented during the participant's unique time slot by tuning the participant's radio to the data channel during the participant's assigned time slot and the radio retuned to the channel previously in use for voice communication. The participant's data will be transmitted during this time slot. The time required for radio tuning, data broadcasting, and radio retuning is sufficiently short, and the time interval between the reoccurrence of the participant's time slot is sufficiently long, that the any interruption in voice communication does not significantly interfere with the voice communication that the radio is being used for.

Summary of One Embodiment of the Invention

Brief Description of An Embodiment of the Present Invention

In one embodiment, the invention relates to a method of communicating between a number of communication devices. The communication devices may be distributed to personnel, or participants. In the inventive method, a common time base is established among the communication devices. The common time base is arranged into a repeating cycle of time intervals that are further arranged into a number of time slots. In one embodiment, at least one time slot is designated as a unique time slot. Preferably, in this embodiment, the unique time slot is common to a plurality of communication devices. During that unique time slot, the communication devices may be tuned from a first frequency to a second frequency. In a preferred embodiment, the communication device returns to the first time frequency, and resumes the first frequency, after the unique time slot has expired. In another preferred embodiment, the communication devices can be directed to maintain the second frequency in order to receive a transmission over the second frequency.

In another embodiment, the invention relates to a method of communicating between a number of communication devices. Again, the communication devices may be distributed to a number of personnel, or participants. In the inventive method, a common time base is established among the communication devices. The common time base is arranged into a repeating cycle of time intervals that are further arranged into a number of time slots. In this embodiment, each communication device is preferably assigned a time slot, the time slot being unique to that communication device. Preferably, a communication device will tune from first frequency to a second frequency on the occurrence of the time slot unique to that communication device. While at the second frequency, the communication device may make a transmission. Preferably, the communication device returns to the first frequency, and resumes the first frequency, following the communication device's unique time slot.

In another embodiment, the invention relates to an apparatus for carrying out one or more of the above described methods. The apparatus preferably has a time slot control unit that is adapted to control when the communication device tunes from the first frequency to a second frequency. The time slot control unit also preferably controls the identity of one or more unique time slots. In a preferred embodiment, the apparatus is capable of receiving a time slot identifier which can communicate with the time slot control unit in order to further control the operating parameters of the communication device.

The above description sets forth, rather broadly, a summary of one embodiment of the present invention so that the detailed description that follows may be better understood and contributions of the present invention to the art may be better appreciated. The some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic diagram illustrating the operation of an embodiment of the invention where a communication device is tuned from a first frequency to a second frequency on the occurrence of a unique time slot.

FIG. 2 is substantially a schematic diagram illustrating the operation of an embodiment of the invention where a communication device is turned from a first frequency to a second frequency on the occurrence of time slot that is unique to that communication device.

FIG. 3 is substantially a schematic representation of display for use in an air traffic control system

FIG. 4 is substantially a schematic representation of a participant location display for use with the methods and apparatus of the invention.

FIG. 5 is substantially a schematic diagram illustrating the operation of an embodiment of the invention where a display is generating using data transmitted from communication devices.

### DESCRIPTION OF AN EMBODIMENT OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

A first embodiment of my invention teaches the inventive art of a radio in use for voice communication on an assigned voice channel being tuned to a frequency assigned for emergency communication. After the emergency communication has been received, the radio is retuned to the channel in previous use for voice communication.

The inventive basis of this patent is the combination of two technologies, in an inventive manner, to achieve the desired objective: the communication of data that is critical to effective fire suppression via the existing radio communications system without interfering with the use of that radio system with ongoing voice communication as presently practiced

The first of these two techniques is that radios can be frequency changed, or channel changed, in a very short time interval. The second pertinent technique is the use of a Time Division Multiple Access (TDMA) communication structure to permit the orderly exchange of data between the many participants involved in a major fire suppression endeavor. These two techniques, when inventively combined, permit this orderly exchange of data without interfering with the use of the radio communication system to continue to provide the currently available voice communication capabilities without interfering with such current capability

In this connection it is pertinent to review these technologies. This review will be significantly based on applicable art technology taught by this inventor, since it is this familiarity that led to this inventive combination to achieve the above stated objectives. The discussion will first consider the frequency agility, or rapid tuning ability, of radios in connection with the development of a highly accurate aircraft navigation system.

Frequency Agility

The frequency of a radio is controlled by an oscillator. In order to achieve frequency stability, a crystal that vibrates with excellence stability at a certain frequency when electrically excited is used to establish a reference frequency, which frequency may be multiplied many times by available conventional circuitry to the frequency required for the operation of the radio in a desired frequency band. In initial practice, when it was desired to change the frequency of operation of the radio, the crystal in use was mechanically exchanged for a different crystal. This mechanical changing process took time.

A basic improvement to this manual tuning process resulted from the development of the frequency synthesizer. A frequency synthesizer consists of circuitry that can electrically generate a wide range of frequencies for radio tuning purposes, all from a single crystal reference. Of additional significance was that this electric tuning process could be significantly shorter in time than the mechanical exchange of a crystal.

A problem that was addressed, and solved, by this inventor using of this frequency agility capability is discussed in my U.S. Pat. No. 3,821,523. In brief, the problem addressed was as follows. As a result of decisions made shortly after World War II, the United States selected a common nationwide navigation system for both civil and military users. The system was called VORTAC, which acronym indicated the merger of the civil VOR system that provided angular data and the military TACAN (Tactical Air Navigation) system that provided both range and angle data. In addition to the installation of numerous VORTAC installations for both civil and military use, there are also many VOR/DME facilities at smaller airports that are primarily used by civil aircraft. VOR/DME provides a VOR bearing signal and the DME distance measuring capability of the VORTAC System.

In this VOR/DME system the VOR component uses a ground-based system that rotates an identifiable antenna pattern, a cardioid, through 360 degrees. In addition, the VOR system radiates a signal that identifies when a known part of a cardioid pattern passes through North. The net result is that circuitry associated with the airborne VOR receiver is able to establish the angular position of the aircraft with respect to the known location of a ground-based VOR System.

The DME, or distant measurement component, operates as follows. An airborne DME interrogator, or transmitter, sends a signal to a DME ground station located with the VOR component. The DME ground station, upon reception of the interrogation, replies with a known time delay. The airborne DME unit, upon receipt of the response, can then establish the range or distance to the ground station by the well known two-way ranging process. The VOR/DME unit in the aircraft is then able to establish the range and bearing to a known surface location, i.e. establish aircraft location for pilot navigation use.

The range accuracy of the DME unit was, and is, quite high, of the order of plus/minus a hundred feet and it is essentially independent of the range to the ground station. The angular accuracy of the bearing information generated in the aircraft by the VOR system is of a nominal magnitude of plus/minus 3.0 degrees. This angular accuracy corresponds to a lateral accuracy of about a mile, or 6,000 ft., when the aircraft is 20 mi. from the ground station. The accuracy increases at shorter ranges and decreasing at greater ranges.

The Federal Aviation Administration (FAA) is responsible for installing and maintaining the VOR/DME ground stations. The FAA also has the responsibility for flight checking the performance of the VOR/DME ground stations, that is whether the signal in space was within a certain range and bearing accuracy tolerance. This flight checking was performed by an aircraft with a well calibrated VOR/DME or VORTAC airborne unit, the location output of which was compared with another more accurate determination of aircraft location. The question of interest was “How to obtain a highly accurate but measurement of aircraft location?”

It was first postulated by that one way of providing excellent location accuracy would be to install multiple DME units in the flight checking aircraft and use these multiple ranging units to provide multiple range measurements to the multiple DME ground stations that were in radio line of sight of the aircraft at altitude. Specifically, because DME ground stations are a key element of the established air navigation system, there are typically 4 to 6 DME ground stations in radio line of sight of an aircraft at altitude.

A next step was to consider using only one DME that was sequentially tuned to the various ground station frequencies. A basic question was the amount of time required to tune an airborne DME from the frequency of one DME ground station to another. This matter was investigated with the finding that the tuning time was only one thousandth of a second, a millisecond, a very short time interval indeed. This finding led to my frequency agile highly accurate aircraft location patent, U.S. Pat. No. 3,821,523.

A first market for this frequency agile navigation system was to provide the FAA a highly accurate positional reference for their flight inspection aircraft. This initial use lead to a worldwide market for flight inspection systems under the Sierra Research (a company that I founded) trade name, SAFI (Semi Automatic Flight Inspection). As the frequency agile navigational concept became publicized, this patented method of obtaining highly accurate location data, on the order of 50 ft., became incorporated into the navigational element of the flight management systems of commercial air transports. It was incorporated for purposes of updating the location of installed inertial navigation (INS) systems. INS systems, which are very accurately aligned prior to takeoff, have a tendency to drift with time outside desirable limits, and hence accurate in flight updating by my patented frequency agile DME concept was beneficially used in this and other applications.

The above provides a review of my teaching with respect to the use of the rapid tuning ability of radios that then had, and obviously still do, millisecond tuning ability. These systems provide a very cost-effective and highly accurate method of establishing aircraft location using existing airborne avionics, with minor additional circuitry, and using existing ground navigational facilities without any addition or modification.

The following discussion reviews my teaching with respect to TDMA communication, the other key technical element of this invention, that when combined with my frequency agility concept provides a cost-effective solution to a primary communication need in fire suppression activities.

Time Division Multiple Access

A Time Division Multiple Access (TDMA) communication system requires a common time base between the participants involved in the communication processes. This common time base can be implemented in a variety of ways depending upon the nature of the communication process and the number of participants involved.

A very early use of a TDMA communication structure to transmit multiple channels of data on a single frequency was taught in my article, entitled A Multiple Channel PAM-FM Radio Telemetry System in the Proceedings of the Institute of Radio Engineers, June 1951. In this early teaching, the problem addressed was that of communicating multiple measurements of data that described the performance of a guided missile in flight. In this case, each channel of data that was communicated was assigned a unique time slot in a repeating cycle of time slots. One of the time slots, known as the time synchronization time slot, which occurred once in the repeating cycle of time slots, was assigned an identifying characteristic.

At the receiving site, this uniquely coded time synchronizing slot was identified and used to set up a time base to establish the repeating cycle of time intervals that contained the data being communicated. This repeating time interval time base was then subdivided, by a counting process, into the individual time slots that contained the individual sets of data being communicated. In this early TDMA communications system of mine, the common time base was established at the broadcasting end and information that permitted its establishment at the receiving end was contained in the signal broadcast.

A next use of TDMA technology, in this case for a navigational application, was taught in my U.S. Pat. No. 3,153,232. The requirement that was addressed in this patent was the need of the United States Navy to fly helicopters close together under poor visibility conditions while they were dipping sonar's into the water for submarine detection purposes. In order for the helicopters not to collide with each other, it was necessary for the pilots of the helicopters to have a display of the location of the other helicopters. There evolved two competing solutions to this Navy requirement.

One solution was to install a miniature secondary surveillance radar (SSR) with a small mechanically rotating directional antenna on each helicopter and display the responses from the transponders in the other helicopters to provide the pilots the location of the other helicopters. This solution had the disadvantage that the operation of multiple secondary surveillance radars, all on the same frequency in close proximity that were randomly interrogating the transponders in the other helicopters, resulted in multiple transponder replies that sometimes overlapped in time and hence caused excessive signal interference. In many ways this airborne SSR concept of the 1960's was a forerunner of the modern day collision avoidance system called TCAS, and hence had the same mutual interference problems as TCAS, but without the availability of modern-day compact digital processing circuitry to provide a solution to the interference problem.

A second solution, the AN/APN-150 covered by the referenced patent, was also, in effect, an SSR. The 150 eliminated signal interference however, by operating in a Time Division Multiple Access manner. Specifically, each helicopter was assigned a unique time slot in a repeating cycle of time slots in which to act as an interrogator and receive transponder replies from the other helicopters. In this manner, mutual interference between the secondary surveillance radars was eliminated. A specific helicopter in the formation, designated as a Master, periodically radiated a synchronizing signal that, when received in the other helicopters, synchronized a clock in the other helicopters for the TDMA function. The 150, when successfully tested in competition with the other system, was produced by the Sierra Research Corp., a company that I founded.

The relative accuracy of the time base established between the multiple helicopters was not high in that the propagation time required for the synchronizing signal to go from the helicopter designated as a master to the other helicopters varied because of their different locations with respect to the Master helicopter. Hence each helicopter had a different propagation time and each time base varied by the variation in the propagation time. The accuracy obtained was adequate enough however, in that the time base only had to be accurate enough that a helicopter performing its surveillance operation in, for example, the middle of its assigned time slot, was not in a time slot assigned to another helicopter and hence generated signal interference. In effect the time slots assigned to each helicopter were made long enough so that this problem did not occur.

In order to increase the number of participants in the next generation of collision avoidance or Station Keeping Equipment (SKE), the AN/APN-169 was developed. The AN/APN-169 was intended for an Air Force application. In developing this device, while retaining the benefits of the gain of the rotating antenna of the 150, which gain was required for the desired coverage in range, recourse was made to one way ranging instead of the two-way ranging of the 150. One way ranging, in contrast to two way ranging, permits an increase in the number of participants by a factor of N, where N is the number of participants in a two way ranging system, without increasing signal interference, other factors being the same.

In order to permit one way ranging, the clocks in each participant had to be very precisely synchronized so that when the transmission from a participating vehicle was received at another vehicle, and timed in its common clock time, the propagation time or range between the transmitting vehicle and a receiving vehicle could be accurately established. The technique used to establish very precise synchronization of the time base in each of the airborne vehicles involved was for the interrogator in each vehicle to first establish, infrequently, the two-way range to the aircraft designated as a master. The master is the aircraft that radiated a synchronizing signal for purposes of establishing a common time base as in the above discussed helicopter system.

With knowledge of this two-way range measurement, and hence the propagation time to the Master, the time of arrival of the synchronizing signal could be corrected for this measurement and hence known propagation time could be used to precisely set the clocks in each of the other vehicles. Once a very precise time base was established, it could be maintained within the required tolerance by the use of an oscillator that employed a highly stable crystal as the frequency reference, until the next infrequent clock setting process was initiated.

The precisely clocked TDMA System used in the AN/APN-169 permits up to 30 aircraft to fly in formation in close proximity without danger of collision for the coordinated droppings of supplies in a designated area. It is standard equipment on C-130s and C-141s. A company that this inventor founded, the Sierra Research Corp., was the developer of the 150 and 169 systems.

Sierra is currently developing an updated version of the 169 for the C-17. It is termed the AN/APN-243. The 243 retains all the features of the 169 plus additional capabilities. One interesting additional capability is that the signals exchanged between the Leader of the formation, and other aircraft in the formation, are coupled to each aircraft's autopilot. This capability permits multiple C-17 aircraft to automatically maintain station on a maneuvering designated leader without pilot intervention.

The above discussed common time bases were established between two participants, as in the case of the missile telemetering or data communication systems, or between eight participants as in the case of the Navy helicopter collision avoidance system, or thirty participants in the case of the Air Force system.

In more recent Time Division Multiple Access communication practice, GPS has become available and provides a highly accurate output of worldwide common time, as well as location. GPS makes the use of a highly accurate, universal, common time base a very simple and straightforward process. For that reason, a GPS unit which can be used to provide location data in this invention can also be utilized to establish a common time base for purposes of this invention.

To summarize the application of my Frequency Agility and Time Division Multiple Access Communication structures to improving communication, normal voice and emergency communication are simultaneously implemented in a non interfering manner by first assigning a unique time slot in a repeating cycle of such time slots, in a common time base, to each participant for Emergency Message Notification (EMN) communication purposes. During this EMN time slot, when an emergency message may or may not be transmitted, an Emergency Message Notification signal will be broadcast indicating that an emergency message will or will not follow. The Emergency Message Notification signal broadcast in the assigned time slot will be transmitted on a frequency allocated for this emergency function.

During this time slot, participant radios intended to receive emergency messages will have their radios, in use for normal voice communication on a channel assigned for voice communication, tuned to receive on the emergency communication channel. This Emergency Message Notification signal, if it indicates that an emergency message will follow, will, when received, act to insure that the participant radio will stay tuned to receive the emergency message for the duration of the emergency message that follows. At the end of the emergency message, the radio will revert to the channel and mode previously in use for normal voice communication. If the emergency message notification signal broadcast indicates that an emergency message will not follow, the radio will then be immediately reset to its previous mode for normal voice communication.

The tuning of the radio to the emergency channel, and the length of the time slot used to broadcast and receive data indicating that an emergency message may or may not follow, is sufficiently short, of the order of a very small fraction of a second, and the time interval between the reoccurrence of the emergency message notification time slots is sufficiently long, that the interruption in an ongoing normal voice communication process does not significantly impact that process. There can, of course, be a noticeable interruption in ongoing voice communication during the broadcast and reception, if it occurs, of the emergency message. Emergency messages will obviously occur infrequently and typically be of short duration, such as “evacuate the building,” hence their impact on normal voice radio communication will be minor.

The channel utilized for the broadcasting of an emergency message could be one normally used for voice communication. The channel could also be one dedicated to such emergency communication use, as well as other data communication uses. One such other use that is compatible with my synchronized time sharing method of communication is the broadcasting of participant data, such as participant location.

This broadcasting of participant data is accomplished by assigning each participant a time slot in a common time base. This time slot is unique to each participant and is in addition to the EMN time slot that is the same for all participants. The unique time slot provides the participant a period to broadcast, in a digital manner, data pertinent to fire suppression activities. Participant location is one such set of data. Participant location, as well as the common time base required to implement my synchronized time sharing method of communication, are readily available using compact low-cost GPS units.

The participant data broadcasting function is implemented during the participant's unique time slot by tuning the participant's radio to the data channel during the participant's assigned time slot and the radio retuned to the channel previously in use for voice communication. The participant's data will be transmitted during this time slot. The time required for radio tuning, data broadcasting, and radio retuning is sufficiently short, and the time interval between the reoccurrence of the participant's time slot is sufficiently long, that the any interruption in voice communication does not significantly interfere with the voice communication that the radio is being used for.

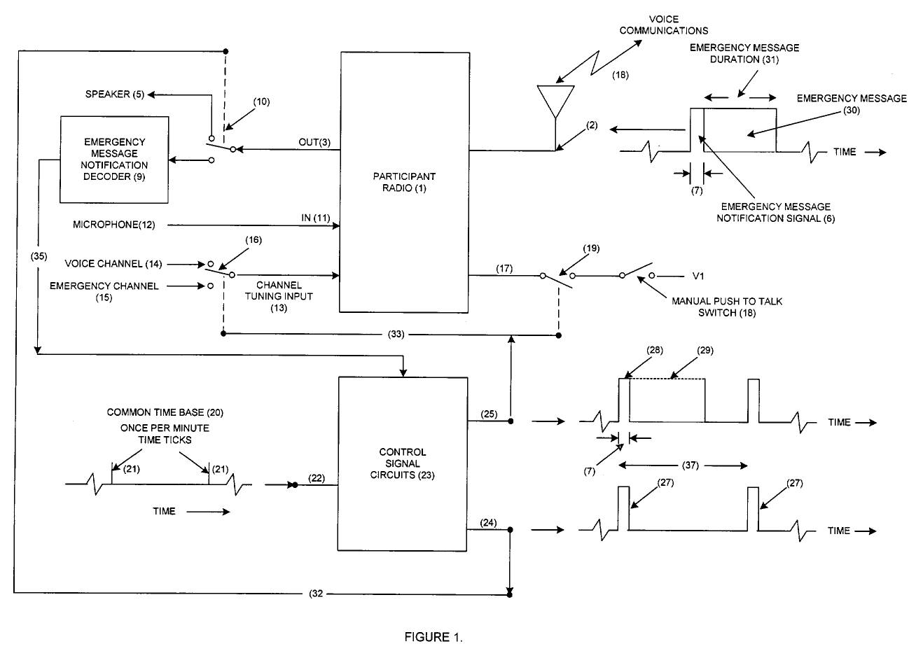

FIG. 1 depicts this embodiment of my invention and shows how radio 1 with antenna 2 that is normally employed for voice communication 18 with another participant, not shown, can also be employed to receive an emergency communication from another location, not shown, in a manner that does not in, in general, interfere with an ongoing voice communication.

In FIG. 1 there are shown four connections to the radio 1. One connection is the signal output line 3 whereby voice 4 is fed to speaker 5 or an emergency message notification signal 6 with duration 7 is fed to an emergency message notification decoder 9 by activation of switching mechanism 10.

A second connection is the voice input 11, which is shown connected to microphone 12. A third connection is the channel tuning input 13, whereby signals corresponding to the voice channel 14 or the emergency channel 15 can be connected to the input 13 by switching mechanism 16.

Another input to the radio is the transmit activation connection 17 that causes, when activated, the radio to change from receiving mode to a transmitting mode. Input 17 is connected to a manual, push to talk, transmit activation switch 18 which, when activated, connects input 17 to voltage V1 by switching mechanism 19. Voltage V1 is normally in the closed mode, but can be opened by switching mechanism 19. Also shown in FIG. 1 is a common time base 20 represented by one per minute time ticks 21. A common time base can be readily provided by available GPS units, not shown. Those of skill in the art will recognize that other time bases could be used and could be supplied by things other than GPS units.

The common time base signal 21 is input on line 22 into control signals circuits 23. The output of control signal circuits 23 are two control signals 24 and 25. Control signal 24 consists of a switch activation signal 27 that occurs during the time slot assigned to the reception of the emergency message notification signal 6. This time slot is shown in figure one to occur in the first time slot that follows the occurrence of time ticks 21. The control signal could occur in other time slots.

Control signal 25 consists of two adjacent signal segments 28 and 29. Segment 28 occurs during the time slot assigned to the reception of the emergency message notification signal. Segment 29, shown dotted, occurs during the broadcast of the emergency message 30 with duration 31.

Operation is as follows. Signal 24 causes switching mechanism 10 to connect radio output line 3 to the emergency message notification decoder 9 during the occurrence of switch activation signal 27. Signal 25 on line 32 causes switching mechanisms 16 to cause the radio 1 to be tuned from the voice channel 33, to channel 34, used for emergency communication, for the duration 7 of the time slot assigned for emergency message notification 6.

Signal 25 on line 33 also causes switching mechanism 19 to open so as to insure that radio 1 is in the receiving mode for the duration 7 of time slot 6. This switching process will insure that radio 1 will stay both in a reception mode and tuned to the emergency channel for the reception and decoding of the emergency message notification signal 6.

If the emergency message notification decoder 9 establishes that the emergency message notification received and decoded states that an emergency message follows, then the emergency message decoder 9 will output a signal on line 35 to control signal circuit 23 to cause signal 25 to stay high 29 during the reception of the emergency message 30. This process insures that the emergency will be outputted on line 3 via switching mechanism 10 for audio output on speaker 5.

If the emergency notification decoder 9 establishes that an emergency message will not follow at the end of the emergency message time slot 27, it will not send a signal on line 35 to control signals circuits 23. The lack of this message will result in the output 25 of control signal circuits 23 to drop and the radio 1 will return to the normal voice communication configuration until the cycle repeats itself.

The duration 7 of the time during which the switch activation signals 24 and 25 will rise to switch activation level is such that the interruption of voice communication 18 for the time duration 7 is sufficiently short, and the time interval 37 between such activation is sufficiently long, so that the associated interruption of voice communication does not preclude the radio being used for voice communication 18.

Normal voice and emergency communication are simultaneously implemented in a non interfering manner by first assigning a unique time slot in a repeating cycle of such time slots, in a common time base, to each participant for Emergency Message Notification (EMN) communication purposes. During this EMN time slot, when an emergency message may or may not be transmitted, an Emergency Message Notification signal will be broadcast indicating that an emergency message will or will not follow. The Emergency Message Notification signal broadcast in the assigned time slot will be transmitted on a frequency allocated for this emergency function.

During this time slot, participant radios intended to receive emergency messages will have their radios, in use for normal voice communication on a channel assigned for voice communication, tuned to receive on the emergency communication channel. This Emergency Message Notification signal, if it indicates that an emergency message will follow, will, when received, act to insure that the participant radio will stay tuned to receive the emergency message for the duration of the emergency message that follows. At the end of the emergency message, the radio will revert to the channel and mode previously in use for normal voice communication. If the emergency message notification signal broadcast indicates that an emergency message will not follow, the radio will then be immediately reset to its previous mode for normal voice communication.

The tuning of the radio to the emergency channel, and the length of the time slot used to broadcast and receive data indicating that an emergency message may or may not follow, is sufficiently short, of the order of a very small fraction of a second, and the time interval between the reoccurrence of the emergency message notification time slots is sufficiently long, that the interruption in an ongoing normal voice communication process does not significantly impact that process. There can, of course, be a noticeable interruption in ongoing voice communication during the broadcast and reception, if it occurs, of the emergency message. Emergency messages will obviously occur infrequently and typically be of short duration, such as “evacuate the building,” hence their impact on normal voice radio communication will be minor.

A second embodiment of my invention teaches the art of incorporating my synchronized data transmission time sharing method, which insures that participants will receive emergency messages, into a TDMA communication structure that also permits multiple participants to communicate digital data, such as GPS location data, without interfering with their ongoing voice communications if the radio is being used for that purpose.

The channel utilized for the broadcasting of an emergency message could be one normally used for voice communication. The channel could also be one dedicated to such emergency communication use, as well as other data communication uses. One such other use that is compatible with my synchronized time sharing method of communication is the broadcasting of participant data, such as participant location.

This broadcasting of participant data is accomplished by assigning each participant a time slot in a common time base. This time slot is unique to each participant and is in addition to the EMN time slot that is the same for all participants. The unique time slot provides the participant a period to broadcast, in a digital manner, data pertinent to fire suppression activities. Participant location is one such set of data. Participant location, as well as the common time base required to implement my synchronized time sharing method of communication, are readily available using compact low-cost GPS units.

The participant data broadcasting function is implemented during the participant's unique time slot by tuning the participant's radio to the data channel during the participant's assigned time slot and the radio retuned to the channel previously in use for voice communication. The participant's data will be transmitted during this time slot. The time required for radio tuning, data broadcasting, and radio retuning is sufficiently short, and the time interval between the reoccurrence of the participant's time slot is sufficiently long, that the any interruption in voice communication does not significantly interfere with the voice communication that the radio is being used for.

The practical implementation of my TDMA multiple participant communication system requires consideration of the number of bits of data that it is desired to transmit in a participant's assigned time slot, the length of the time slot required to transmit that data, and the number of participants that can be accommodated in the time interval allocated to the transmission of data by all participants-that is, the time interval before the data transmission cycle repeats itself.

A starting point in this discussion is to note that the most important data that is transmitted via the communications system employed in the previously discussed Airborne Dependent Surveillance-Broadcast [ADS-B] system is participant location. Participant location in ADS-B is GPS derived. In the case of the ADS-B UAT link, the number of bits utilized in broadcasting a location message is approximately 250. These 250 bits contain the precise three-dimensional location of the participant, the velocity of the participant in the noted dimensions, the identity of the participant, as well as error correcting bits etc.

In the case of participants involved in fire suppression activities using my TDMA communication structure, the identity of a participant can be established via the time slot to which the participant has been assigned. Elevation data is not required because participant elevation is established by Geographical Information System [GIS] data available at the Incident Commander (the Incident commander may be a fire chief or a fire commander, among others) site and the broadcast location of the participant. In addition, the state vector (providing motion data) is not required because of the slow movement of the participant (in contrast to aircraft motion). Participant motion can be established satisfactorily, if required, by tracking data on the participant. In summary it is thus very conservative to assign a similar number of bits, that is 250 bits per message, for transmitting participant location and or other messages in this embodiment. However, those of skill in the art will recognize that more bits could be used, if desired, including to transmit elevation and motion data.

The UAT link used in ADS-B transmits at a bit rate of a million bits per second. Their 250 bit message thus lasts 0.25 milliseconds. In the case of a voice radio with a 10,000 bits per second transmission capability, a 250 bit message lasts 100 times longer, or 25 milliseconds. A next question is the number of participants that can be accommodated in the time interval available before the UAT broadcasting cycle is repeated.

The UAT repetitive time interval is one second. On this basis it might be initially assumed that some 4000 participants can be accommodated in the one second interval using a TDMA communication structure. However, the UAT link does not use a TDMA communication structure because each aircraft transmits at a random time in the once second repetitive cycle. In actual UAT practice, when the number of participants involved in such random transmission exceeds about 500, the messages tend to become garbled because they overlap when they arrive at a participant. This means that a participant might have to wait several seconds to receive a non-garbled message when the number of participants becomes quite large.

The reason for UAT randomly transmitted messages becoming garbled when a large number of participants are involved is that, while the message length is only about 0.25 milliseconds long, there is a random radio propagation delay between participants of up to four times this amount, or a millisecond. This random additional delay is caused by the fact that a message transmitted by an adjacent aircraft will arrive at a first participant without a noticeable propagation delay, but when the message is transmitted by a participant aircraft 150 miles away, it will take up to a millisecond to arrive at the first participant.

The net result is that in a UAT TDMA communication structure, a time of 0.25 milliseconds must be allocated to data transmission and a millisecond to random propagation delays between transmitting and receiving participants for a total slot width of 1.25 milliseconds. In the one second interval between updates, this potentially allows about 800 participants in a UAT TDMA communication structure without message garbling.

An additional practical consideration in using a TDMA communication structure in ADS-B practice is that each participant must be assigned a unique time slot. In aircraft operations, this poses a problem because each aircraft flying into an area with other participants must be assigned a unique time slot not occupied by an aircraft already in the propagation coverage in that area. An alternative solution, utilized in the UAT link, is to employ random transmissions and experience garbled messages and the associated but acceptable delay in receiving non garbled messages when the number of participants in the propagation coverage area becomes large.

In contrast, the random propagation delays of ground fire suppression participants randomly located, typically at most 50 mi. apart, is 0.3 milliseconds. This time is only a small fraction of the 25 millisecond length of the noted participant data time slot employed with voice radios with a 10,000 bits per second capability and therefore is not a practical consideration in terms of structuring a TDMA communications system for multiple ground participants using voice radios. In addition, in fire suppression activities, in contrast to aircraft operations, the participants are not continuously entering and leaving the fire area at a high rate of speed. Therefore, the participants can be readily assigned a unique time slot for the period they are engaged in suppression activities.

In the case of my TDMA communication structure for ground participants employing radios with a 10,000 bit per second capability, some forty 250 bit long messages, lasting 25 milliseconds each, can be broadcast in each second. However, as noted previously, the motion of ground participants is significantly slower than that of aircraft and therefore a much slower update rate can be satisfactorily utilized. With an update rate of every 60 seconds, for example, some 2400 participants can be accommodated without garbling using my TDMA structure.

The time interval, arbitrarily allocated, in this embodiment for the transmission of participant data is a repeating cycle of sixty seconds. This 60 second interval can accommodate 2400 participants, or participant radios, without interference. While 2400 participants and participant radios might be involved in some major incidents, a probably more realistic number is much less, thus permitting a faster update rate than the noted 60 seconds. For example, a 10 second update rate can still accommodate 400 participants.

However, the update rate cannot be made too fast without the possibility of the interruption in voice communication due to data transmission becoming a detriment to such voice communication. In any event, the update rate, number of participants, participant slot width, and the number of bits that can be communicated in the slot that are permitted by my inventive embodiments are such that they should more than satisfy operational needs. Actual field experience involving different types of fire suppression or other activities will lead to the numbers actually utilized in later practice. Furthermore, those of skill in the art will be able to alter the parameters of my invention to suit their needs, and will be able to take into account changes in technology that might affect the performance capabilities of the devices used in my invention (for example, the development of radios with higher transmission rates).

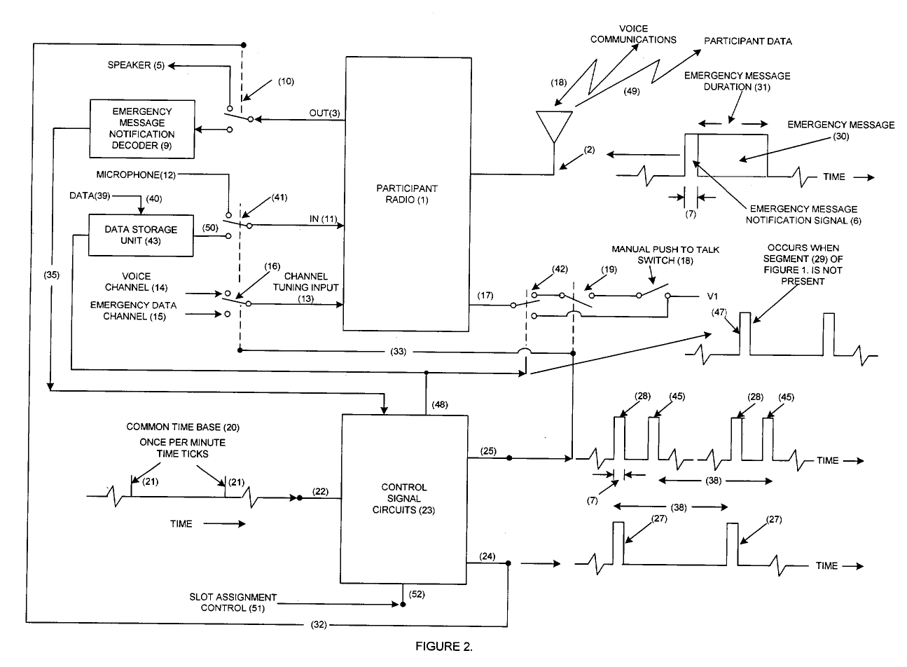

FIG. 2 depicts this embodiment of my invention and is similar to FIG. 1 except for the addition of switching mechanisms 41 and 42 and the addition of data storage unit 43, with data input 39, on line 40. In addition, a slot assignment control 51 is shown inputted into control signals circuits 23 via input 52. The control signal circuit 23 also outputs an added signal 47 on line 48.

The following discussion of the operation of FIG. 2 assumes that an emergency message, which occurs very infrequently, is not being transmitted and hence segment 29 of FIG. 1 is not occurring. Operation is as follows.

Control signal circuits 23 generate an additional switch activation signal 45 on line 25 that occurs in a time slot unique to each participant. The occurrence of the unique participant time slot, in the interval between time ticks 21, is selected by slot assignment control 51. This additional signal 45 on line 25 acts on switching mechanisms 16 and 41 via line 33 to insure that the radio is tuned to the emergency message/data channel and that the radio input 11 is connected to data storage unit 43 during the duration of participant assigned time slot 45, which is coincident in time with signal 47.

Data 39, such as GPS location data, is fed into data storage unit 43 on line 40. Signal 47 acts through switching mechanism 42 to cause the data storage unit 43 to shift stored data 50, such as GPS location data into the radio 1 on line 11 for broadcast. Broadcast 49 of the data is caused by signal 47 acting on switch control mechanism 42 to cause line 17 to be connected to voltage V1 for the duration of the participant's assigned time slot.

The signal on line 48 from control signals circuits 23 is not generated during the duration of segment 29, of FIG. 1, if it occurs, in order to insure the absence of participants' transmission of data during their assigned time slot. This is done to insure that no participant transmissions occur during the duration of segment 29 because such transmissions could interfere with participant reception of an emergency message during this time interval 29.

The embodiment depicted in FIG. 2 thus permits multiple participants to broadcast data on the data/emergency message channel in a specifically assigned time interval, which interval is short enough so as not to interfere with voice communication on the radio that is being used for such a purpose. Page 37 of 54

While this embodiment teaches the art of a radio, nominally in use for voice communication on an assigned voice channel, being tuned to a data channel during a short assigned time slot for the transmission of data, nothing in this embodiment precludes a radio, not in current use for voice communication, but standing by, being assigned a unique time slot for the transmission of data, and transmitting that data such as the location of a participant not in current voice communication.

A radio, not in use for voice communication, could also be assigned a time slot dedicated to the transmission of data, such as temperature, humidity wind velocity etc., provided by sensors installed in the fire area. This atmospheric data, for example, would be provided by the sensors in a digital manner, such as the nominal 250 bits used to transmit GPS location, but identified as sensor data. This sensor data would be inputted into the data storage unit 43 on line 40.

As discussed, a slot assignment slot control 50 can be used to establish the time slot assigned to a radio used by a participant. The slot assignment slot control is a module that is plugged into a participant radio via input 51 of control signal circuits 23. My next embodiment relates to the generation and display of the communicated participant data at a Fire Commander Center and is pertinent to the use of the slot assignment control module 51.

Before moving on to an additional embodiment of my invention, it should be noted that those of skill in the art will appreciate that many different methods can be used to assign a participant a particular time slot and/or identify a participant. For example, the radio could have a memory register that would be capable of reviewing and holding the identity of the time slot assigned to the radio. The memory register could be programmed by the participant, could be set prior to the participant receiving the radio, and/or could be remotely programmed, for example in response to a signal sent out from a central command location. The radio could be programmed using a portable memory storage device, such as compact flash cards and smart media cards. The radio could be set so that a user could set the time slot by means of an input mechanism, such as a dial, keypad, etc.

In addition, the radio could be provided with means for changing other parameters of the TDMA structure, such as the refresh rate. In particular, a dynamic process of assigning time slot, setting the refresh rate, and other parameters, would allow the central command personnel great flexibility in optimizing radio communication with and between the participants.

The next embodiment of my invention teaches the art of the generation and use of a display of participant data, such as location data, at a fire command center for both overall direction of fire suppression activities, as well as the issuance of emergency messages. In many ways, such a fire commander display is similar to that utilized in air-traffic control practice.

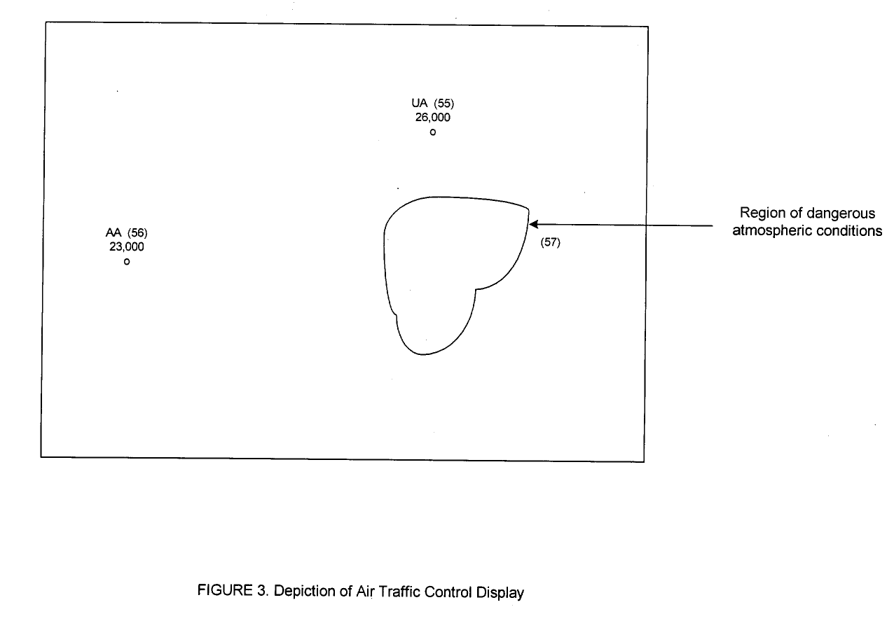

In current air-traffic control practice, an air-traffic controller views a display such as that of FIG. 3. FIG. 3 depicts the location, including altitude, and identifying information of various aircraft. Also shown in FIG. 3 are contours 57 of potentially dangerous atmospheric conditions, such as wind shear, severe turbulence etc., in the area. The annotations can be, for example, provided by the Nexrad radars of the National Weather Service, which are being installed to provide such data. These annotations can be used by the air-traffic controller to direct an aircraft away from regions of dangerous atmospheric conditions that could be detrimental to the safety of the aircraft. Aircraft location, in current practice, is provided by a surveillance radar, and in emerging practice, by the use of ADS-B technology (that is, the broadcast of the GPS derived location of the aircraft involved).

In this embodiment, data, such as location etc., from multiple participants is broadcast in a TDMA manner for reception and use at one more locations, not shown in FIG. 2. One such location could be that of a central control figure, such as a fire commander. At the fire commander location there could be additional data available, such as the contour of the fire. This additional data, together with data received from the multiple participants, could be used to generate a display for fire commander viewing, just as in air-traffic control practice. Such a display would be extremely useful for the control and dispatching of participants, while at the same time ensuring safety.

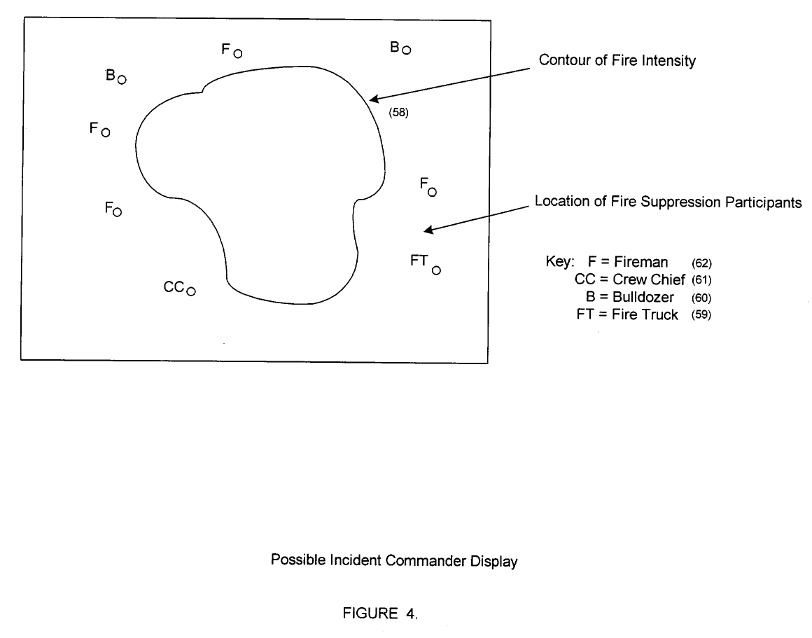

One display that could be useful to a fire commander, or other central command figure, is provided in FIG. 4. FIG. 4 depicts the location of the participants, communicated as in this embodiment, with respect to the fire line 58. The location of the fire line could be provided by any number of means, including using an airborne infrared sensing system, and this location communicated to the fire commander site in some manner, not discussed, for use at that location.

In a severe fire there are multiple aircraft involved in air operations such as dropping fire retardant, carrying an airborne fire commander etc. Such aircraft could be used to carry an infrared sensing system for fire detection and communication to the fire commander site.

The symbolism used in FIG. 4 indicates the characteristics of the participant broadcasting the data i.e. fire truck 59, bulldozer 60, crew chief 61, or ordinary fireman 62 etc. This symbolic data can be made available at the fire command center, or other locations, for display annotation, in the following manner.

As noted previously, a plug-in slot assignment control module is used to establish the slot assignment allocated to each participant radio. In the case of a participant radio that is essentially permanently attached to a vehicle, such as a fire truck, the slot assignment control module would be permanently attached to the vehicle's radio. In the case of personnel involved in the fire suppression, each person would be assigned a slot assignment control module that they would insert into the radio they would be using.

At the command center there would be a listing of the slot assignment modules in terms of which participants they were issued to, i.e. fireman, crew chief, bulldozers etc. That list, imbedded or programmed in the computer used to generate the display, would be used to appropriately annotate the FIG. 4 display. The time of arrival of a specific time slot, containing data such as location data, would identify the participant, and hence the information in the list pertaining to that participant.

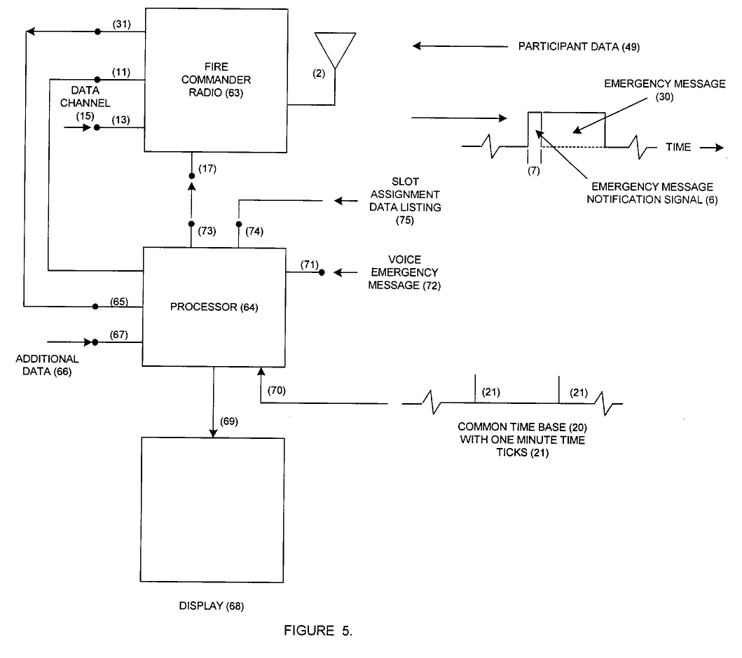

FIG. 5 outlines the operation of this embodiment. In FIG. 5 there is shown a radio 63. Radio 63 is similar to a participant radio but is dedicated to the reception of broadcast participant data at a Fire Commander Center or other appropriate location where it is desirable provide a display of participant data. The radio 63 is tuned, via input 13, to data channel 15.

The output 3 of the radio is fed to a processor 64 via processor input 65. Also fed into processor 64, on line 67, is additional data 66, such as data pertaining to the generation of the fire contour 58. Processor 64 is used to drive a display 68 similar to the display of FIG. 4, via line 69. Also fed into processor 64, on line 70, is the common time base 20 with one minute time ticks 21. Also fed into processor 64, on line 71, is the voice emergency message 72. Processor 64 also outputs, on line 73, a signal into the fire commander's radio 63 via input 17 to control the transmission or reception mode of radio 63. Also inputted into processor 64, on line 74, is slot assignment data 75, i.e. what slot is assigned to what participant and the nature etc. of that participant (crew chief, bulldozer, etc.). Operation is as follows.

Processor 64 with inputted one minute time ticks 21 establishes a common time base within the processor, including the time, in common time, at which individual time slots occur. At the occurrence of the first time slot following the occurrence of a one minute time ticks, processor 64 outputs, on line 73, a signal into the radio 63, on line 17, placing the radio into the transmitting mode, so as to transmit an emergency message notification signal. That emergency notification signal will indicate whether an emergency message will or will not immediately follow. The determination as to whether an emergency message will or will not follow is established by whether an emergency voice message has been inputted into processor 64, on line 71, and stored in the processor for transmission following the occurrence of the emergency message notification time slot. Voice storage, and subsequent broadcasting on a notification signal, is a well practiced art as, for example, in telephone answering machines.

If an emergency message is not stored for immediate transmission, the emergency message notification signal will so indicate and, in addition, processor 64 will send a signal on line 73, inputted into radio 63, on line 17, to cause radios 63 to be in the receiving mode until the next one minute time ticks, that is, until the cycle of TDMA time slots repeats itself.

If an emergency message is stored awaiting transmission, processor 64 will output a signal on line 73 to radio 63 on input 17 so as to maintain radio 63 in the transmitting mode for the duration of the stored emergency message. At the end of the emergency message, processor 64 will output a signal to radio 63 on line 73 to cause radios 63 to return to the receiving mode until the next occurrence of the emergency message notification time slot, that is the occurrence of the next one minute time tick.

The processor 64 will receive participant data in successive time slots. Upon the receipt of a data from an individual time slot, processor 64 will note the time of occurrence, that is the identification of that time slot and will annotate the data received, such as location, with the data stored in the processor via the slot assignment data listing, inputted into processor 64 on line 75.

This received participant data, together with annotations, will then be used to generate a display 68, similar that of FIG. 4, for fire commander viewing. The fire commander, or an assistant, will use display 68 to conduct suppression operations in the most efficient and safe manner and site third test issue emergency messages 72 via voice input into processor 64 on line 71

### Conclusion

Although the description above contains many specifications, these should not be construed as limiting the scope of the invention but as merely providing illustrations of some of presently preferred embodiments of this invention. The disclosed invention may be used in many fields, and is not limited to use fire suppression or any other activity. In addition to being of general applicability, the disclosed method can be carried out by using the disclosed devices, systems, and methods, as well as other devices, systems, and methods now existing or which may be developed in the future. Such adaptation is well within the skill of the routineer in the art. Thus, the scope of the invention should be determined by the appended claims and their legal equivalents rather than by the examples given.

What is claimed is:

1. A method for communication, comprising the steps of, but not necessarily in the order shown:
(A) providing a plurality of communication devices;
(B) establishing a common time base among the plurality of communication devices;
(C) arranging the common time base into a repeating cycle of time intervals;
(D) arranging the repeating cycle of time intervals into a plurality of time slots, wherein each time slot has a duration;
(E) designating at least one unique time slot; and
(F) tuning at least one of the plurality of communication devices from a first frequency to a second frequency when at least one of the at least one unique time slots occurs.

2. The method of claim 1 wherein one of either the first or second frequency is used for voice communication and the communication over the other frequency comprises data.

3. The method of claim 2 wherein tuning the communication device from the first frequency to the second frequency does not significantly interfere with voice communication.

4. The method of claim 1 wherein each time slot has a duration between about 1 millisecond and about 500 milliseconds.

5. The method of claim 1 wherein the communication devices are radios.

6. The method of claim 5 wherein the communication devices are handheld radios.

7. The method of claim 1 further comprising detecting for a signal when the communication device is tuned to the second frequency.

8. The method of claim 7 wherein the communication device is maintained at the second frequency if the signal is detected.

9. The method of claim 8 further comprising detecting for a second signal, wherein the communication device is maintained at the second frequency when the second signal is detected.

10. The method of claim 8 further comprising detecting for a second signal, wherein the communication device returns to the first frequency when the second signal is detected.

11. The method of claim 8 wherein the detected signal indicates the duration the communication device should be maintained at the second frequency.

12. The method of claim 7 wherein the communication device returns to the first frequency when the signal so indicates.

13. The method of claim 7 wherein the communication device is maintained at the second frequency when the signal so indicates.

14. The method of claim 7 wherein the communication device returns to the first frequency when the signal is detected.

15. The method of claim 7 wherein the communication device returns to the first frequency when no signal is detected.

16. The method of claim 7 wherein the communication device is maintained at the second frequency if no signal is detected.

17. The method of claim 7 wherein the detected signal indicates the duration the communication device should be maintained at the second frequency.

18. The method of claim 7 wherein the signal is an emergency message notification signal.

19. The method of claim 18 further comprising an emergency message having a duration and wherein the communication device is maintained at the second frequency for the duration of the emergency message.

20. The method of claim 1 wherein the common time base is supplied by Global Positioning System.

21. The method of claim 1 wherein the communication device is capable of using Global Positioning System data.

22. The method of claim 1 wherein the communication device remains tuned to the second frequency for the duration of the unique time slot.

23. The method of claim 1 wherein at least one of the at least one unique time slot is common to a plurality of the plurality of communication devices.

24. The method of claim 1 wherein at least one of the at least one unique time slot is common to all of the communication devices.

25. The method of claim 1 further comprising tuning the communication device from the second frequency back to the first frequency.

26. The method of claim 25 wherein the length of time the communication device is maintained at the second frequency does not substantially interference with voice communication on the first frequency.

27. The method of claim 26 wherein the length of time the communication device is maintained at the second frequency is about 500 milliseconds or less.

28. The method of claim 1 further comprising transmitting a signal on the second frequency during the unique time slot, wherein the signal causes at least a second plurality of the plurality of communication devices to tune to the first frequency.

29. The method of claim 28 further comprising transmitting a message to the second plurality of communication devices following the unique time slot.

30. The method of claim 29 wherein the message is a voice emergency message.

31. A method for communication, comprising the steps of, but not necessarily in the order shown:
(A) providing a plurality of communication devices;
(B) establishing a common time base among the plurality of communication devices;
(C) arranging the common time base into a repeating cycle of time intervals;
(D) arranging the repeating cycle of time intervals into a plurality of time slots, wherein each time slot has a duration;
(E) assigning at least one time slot to each communication device, wherein the assigned time slot is unique to each communication device;
(F) tuning at least one of the plurality of communication devices from a first frequency to a second frequency when at least one of the at least one unique time slots occurs; and
(G) transmitting from the at least one of the plurality of communication devices while the communication device is tuned to the second frequency.

32. The method of claim 31 wherein one of either the first or second frequency is used for voice communication and the communication over the other frequency comprises data.

33. The method of claim 32 wherein tuning the communication device from the first frequency to the second frequency does not significantly interfere with voice communication.

34. The method of claim 31 wherein each time slot has a duration between about 1 millisecond and about 500 milliseconds.

35. The method of claim 31 wherein the communication devices are radios.

36. The method of claim 35 wherein the communication devices are handheld radios.

37. The method of claim 31 wherein the common time base is supplied by Global Positioning System.

38. The method of claim 31 wherein the communication device is capable of using Global Positioning System data.

39. The method of claim 31 wherein the transmission occurring while the communication device is tuned to the second frequency comprises data.

40. The method of claim 31 further comprising designating at least a second time slot, wherein the second time slot is common to each of the plurality of communication devices.

41. The method of claim 40 further comprising tuning at least one of the plurality of communication devices from a first frequency to a second frequency when at least one of the at least a second time slot occurs, wherein the communication device remains tuned to the second frequency for the duration of the second time slot.

42. The method of claim 31 further comprising detecting for a signal when the communication device is tuned to the second frequency.

43. The method of claim 42 wherein the communication device is maintained at the second frequency if the signal is detected.

44. The method of claim 42 wherein the communication device returns to the first frequency when the signal is detected.

45. The method of claim 42 wherein the communication device returns to the first frequency when no signal is detected.

46. The method of claim 42 wherein the communication device is maintained at the second frequency if no signal is detected.

47. The method of claim 42 wherein the communication device returns to the first frequency when the signal so indicates.

48. The method of claim 42 wherein the communication device is maintained at the second frequency when the signal so indicates.

49. The method of claim 42 further comprising detecting for a second signal, wherein the communication device is maintained at the second frequency when the second signal is detected.

50. The method of claim 42 further comprising detecting for a second signal, wherein the communication device returns to the first frequency when the second signal is detected.

51. The method of claim 50 wherein the detected second signal indicates the duration the communication device should be maintained at the second frequency.

52. The method of claim 42 further comprising detecting for a second signal.

53. The method of claim 52 wherein the detected second signal indicates the duration the communication device should be maintained at the second frequency.

54. The method of claim 31 further comprising generating a display utilizing the transmission from the communication device occurring when the communication device is tuned to the second frequency.

55. The method of claim 54 wherein the transmission comprises data.

56. The method of claim 55 wherein:
(A) the display comprises a map;
(B) the data comprises location data; and
(C) the location data is used to generate the communication device's location on the map.

57. The method of claim 56 wherein a communication device's identity is determined by the time slot assigned to the communication device.

58. The method of claim 31 wherein the communication device remains tuned to the second frequency for the duration of the unique time slot.

59. The method of claim 31 further comprising tuning the communication device from the second frequency back to the first frequency.

60. The method of claim 59 wherein the length of time the communication device is maintained at the second frequency does not substantially interfere with voice communication occurring on the first frequency.

61. A communication device comprising:
(A) a handheld case;
(B) a transmitter located inside the case, wherein the transmitter is capable of being tuned between at least a first and second frequency.
(C) a receiver located inside the case, wherein the receiver is capable of being tuned between at least a first and second frequency;
(D) a processor located inside the case and in communication with the transmitter and receiver;
(E) a time slot control unit located inside the case and in communication with the processor;
(F) a speaker adapted to broadcast sound in response to signals sent by the processor; and
(G) an audio input adapted to convert external sound into signals that are communicated to the processor.

62. The apparatus of claim 61 further comprising a time slot identifier, the time slot identifier adapted to be inserted into the housing and be placed in communication with the time slot control unit.

63. The apparatus of claim 62 wherein the time slot identifier completes a circuit with the time slot control unit.

64. The apparatus of claim 62 wherein the time slot identifier transmits data to the time slot control unit.

65. The apparatus of claim 61 wherein the transmitter is capable of transmitting at least about 8000 bits per second.

66. The apparatus of claim 61 wherein the transmitter can be tuned between the first and second frequencies in at least about 10 milliseconds.

67. The apparatus of claim 61 wherein the receiver can be tuned between the first and second frequency in at least about 10 milliseconds.
